(19) United States
(12) Patent Application Publication
(10) Pub. No.: US 2002/0035176 A1
(43) Pub. Date: Mar. 21, 2002

(54) Flame retardant, high impact monovinylidene aromatic polymer composition

(76) Inventors: Bruce A. King, Midland, MI (US); Nicole H. Groot, Terneuzen (NL)

Correspondence Address: THE DOW CHEMICAL COMPANY, INTELLECTUAL PROPERTY SECTION, P. O. BOX 1967, MIDLAND, MI, 48641-1967, US

(21) Appl. No.: 09/798,474

(22) Filed: Mar. 2, 2001

Related U.S. Application Data
(60) Provisional application No. 60/188,860, filed on Mar. 13, 2000.
(60) Provisional application No. 60/237,307, filed on Oct. 2, 2000.

(51) Int. Cl. C08K 5/52; C08G 63/48

(52) U.S. Cl. 524/140; 525/64

(57) ABSTRACT

Disclosed is a flame retardant, high impact monovinylidene aromatic polymer composition comprising suitable and sufficient amounts of a rubber modified monovinylidene aromatic polymer, a polyphenylene ether resin, a phosphorous compound, and an optional amount of phenol/aldehye resin as a partial substitute for the polyphenylene ether resin, which composition is rated V-2, V-1, V-0, or 5V in the Underwriter's Laboratories Standard 94 flammability test. More particularly the present invention provides a flame retardant, high impact monovinylidene aromatic polymer composition which can be easily processed comprising:

(A) from 40 to 85 percent, based on the total weight of said composition, of comprising a rubber modified monovinylidene aromatic polymer

(B) from 10 to 40 weight percent, based on the total weight of said composition, of a polyphenylene ether resin; and

(C) from 5 to 20 weight percent, based on the total weight of said composition, of a phosphorous compound.

Also disclosed the method of preparing the above-mentioned flame retardant compositions.

### CROSS REFERENCE STATEMENT

This application claims the benefit of U.S. Provisional Application No. 60/188,860, filed Mar. 13, 2000 and U.S. Provisional Application No. 60/237,307.

### BACKGROUND OF THE INVENTION

The present invention relates to high impact monovinylidene aromatic polymer compositions having improved flow properties with attendant ease in the fabrication of articles made therefrom. The present invention also relates to flame retardant, high impact monovinylidene aromatic polymer compositions and the process for producing such compositions.

Polymers derived from styrene have been used commercially in a numerous end-use applications for a number of years. Such polymers include the high impact modifications thereof in which the impact strength is improved by incorporating a minor amount of a toughening agent, such as a suitable rubber, during the polymerization. It is also known to improve the flame or ignition resistance of styrenic polymer, including high impact modifications, by incorporating various flame retardant additives.

An effective approach to imparting flame resistance to styrenic polymer composition is disclosed in Haaf et al, U.S. Pat. No. 4,107,232, which teaches the use of polyphenylene ether resins in connection with a flame retardant component, such as triphenyl phosphine oxide, and a polytetrafluoroethylene to control dripping often encountered during an established laboratory burn tests. A key disadvantage of such compositions has been the difficulty one often experiences while trying to process such compositions using various well know extrusion or injection molding processes. More particularly, polyphenylene ether resins, having relatively high molecular weight, increases the viscosity of the extrudate, rendering it more difficult to process through extrusion or injection molding equipment. Therefore, it remains highly desirable to obtain a monovinylidene aromatic polymer composition having a unique combination of effective flame resistance, high impact resistance and improved melt flow, with a reduced tendency to drip during Underwriter's Laboratories Standard 94 (UL-94) flammability testing.

### SUMMARY OF THE INVENTION

One aspect of the present invention is high impact monovinylidene aromatic polymer compositions having improved flow properties comprising

(A) from 60 to 90 percent, based on the total weight of said composition, of comprising a rubber modified monovinylidene aromatic polymer; and

(B) from 10 to 40 weight percent, based on the total weight of said composition, of a polyphenylene ether resin.

Another aspect of the present invention is a flame retardant, high impact monovinylidene aromatic polymer composition comprising suitable and sufficient amounts of a rubber modified monovinylidene aromatic polymer, a polyphenylene ether resin, a phosphorous compound, and an optional amount of phenol/aldehye resin as a partial substitute for the polyphenylene ether resin, which composition is rated V-2, V-1, V-0, or 5V in the Underwriter's Laboratories Standard 94 flammability test.

Another aspect of the present invention provide a flame retardant, high impact monovinylidene aromatic polymer composition comprising:

(A) from 40 to 85 percent, based on the total weight of said composition, of comprising a rubber modified monovinylidene aromatic polymer

(B) from 10 to 40 weight percent, based on the total weight of said composition, of a polyphenylene ether resin; and

(C) from 5 to 20 weight percent, based on the total weight of said composition, of a phosphorous compound.

Another aspect of the present invention is the above-identified flame retardant composition wherein from 5 to 20 weight percent, based on the total weight of said composition, of a phenol/aldehyde resin is partially substituted for the polyphenylene ether resin with corresponding reduction of the amount thereof. Yet another aspect of the present invention is a process for preparing the aforementioned flame retardant monovinylidene aromatic polymer composition.

It has been discovered that the flame retardant composition of the present invention has increased gloss and is easier to process, while maintaining excellent impact properties.

### DETAILED DESCRIPTION OF INVENTION

Component (A) in the flame retardant high impact monovinylidene aromatic polymer composition of the present invention is a rubber modified monovinylidene aromatic polymer further described in detail hereinbelow.

Monovinylidene aromatic polymers suitable for use as a matrix in the preparation of the rubber modified monovinylidene aromatic polymer are those produced by polymerizing a vinyl aromatic monomer. Vinyl aromatic monomers include, but are not limited to those described in U.S. Pat. Nos. 4,666,987, 4,572,819 and 4,585,825, which are herein incorporated by reference. Preferably, the monomer is of the formula:

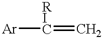

wherein R is hydrogen or methyl, Ar is an aromatic ring structure having from 1 to 3 aromatic rings with or without alkyl, halo, or haloalkyl substitution, wherein any alkyl group contains 1 to 6 carbon atoms and haloalkyl refers to a halo substituted alkyl group. Preferably, Ar is phenyl or alkylphenyl, wherein alkylphenyl refers to an alkyl substituted phenyl group, with phenyl being most preferred. Typical vinyl aromatic monomers which can be used include: styrene, alpha-methylstyrene, all isomers of vinyl toluene, especially paravinyltoluene, all isomers of ethyl styrene, propyl styrene, vinyl biphenyl, vinyl naphthalene, vinyl anthracene and the like, and mixtures thereof. The vinyl aromatic monomers may also be combined with other copolymerizable monomers. Examples of such monomers include, but are not limited to acrylic monomers such as acrylonitrile, methacrylonitrile, methacrylic acid, methyl methacrylate, acrylic acid, and methyl acrylate; maleimide, phenylmaleimide, and maleic anhydride. The polymerization of the vinyl aromatic monomer is conducted in the presence of predissolved elastomer to prepare impact modified, or grafted rubber containing products, examples of which are described in U.S Pat. Nos. 3,123,655, 3,346,520, 3,639,522, and 4,409,369, which are incorporated by reference herein.

The rubber present in the composition of the present invention is in the form of discrete, dispersed rubber particles comprised of a) a star branched diene rubber having a cis 1,4 structure content of less than 75 weight percent, and b) a linear diene rubber, having a cis 1,4 structure content of less than 50 weight percent. It has been surprisingly discovered that a blend of such rubbers will perform as well or better than compositions wherein the star branched rubber is used alone. The star branched rubber of a) is a low viscosity rubber having a solution viscosity (5% in styrene at 20° C.) in the range of 20 to 120 centipoise (cps), preferably 25 to 100, more preferably 25 to 60 and most preferably 30 to 50, and a Mooney viscosity (ML4, 100° C.) of 30 to 80, preferably 35 to 75, more preferably 35 to 60 and most preferably 50 to 60. Suitable rubbers include radial or star branched rubbers having three or more polymer segments bonded to a single polyfunctional element or compound, and branched rubbers having a cis 1,4 structure content of less than 75 weight percent and at least one, or a significant number of subordinate chains of sufficient length such that the viscosity of the rubber is less than the viscosity of a linear polymer of the same monomeric components and same molecular weight. These rubbers typically have a relatively high average molecular weight, a relatively low solution viscosity and a medium to high Mooney viscosity. In general, the solution viscosity for the rubber will be below 120 cps, while the Mooney viscosity will be less than 80.

The radial or star branched rubber preferably employed in the present invention, typically exhibits a second order transition temperature not higher than about 0° C., and preferably not higher than about −20° C. Suitable rubbers include alkadienes which include 1,3-conjugated dienes such as butadiene, isoprene, chloroprene or piperylene. Most preferred are homopolymers prepared from 1,3-conjugated dienes, with homopolymers of 1,3-butadiene being especially preferred. Alkadiene copolymer rubbers containing small amounts, for example up to 10 or 15 weight percent, of other monomers such as vinyl aromatics can also be employed if the rubbers meet the other qualifications described herein.

Rubbery polymers having random branching, as well as methods for their preparation, are known in the art and reference is made thereto for the purpose of this invention. Representative branched rubbers and methods for their preparation are described in Great Britain Patent No. 1,130,485 and in Macromolecules, Vol. II, No. 5, pg. 8, by R. N. Young and C. J. Fetters.

Radial or star branched polymers, commonly referred to as polymers having designed branching, are conventionally prepared using a polyfunctional coupling agent or a polyfunctional initiator. Methods for preparing star branched or radial polymers having designed branching are well-known in the art. Methods for preparing a polymer of butadiene using a coupling agent are illustrated in U.S. Pat. Nos. 4,183,877; 4,340,690; 4,340,691 and 3,668,162, whereas methods for preparing a polymer of butadiene using a polyfunctional initiator are described in U.S. Pat. No. 4,182,818; 4,264,749; 3,668,263 and 3,787,510, all of which are herein incorporated by reference.

As known by those skilled in the art, various techniques such as control of the branching and molecular weight control can be used to adjust and tailor these polymers to achieve the necessary solution and Mooney viscosities, as well as the ratio of these two.

The linear diene rubber of b) can be any linear diene rubbery polymer having a cis 1,4 structure content of less than 50, preferably less than 45, and more preferably less than 40 weight percent. Preferred rubbery polymers include a homopolymer or copolymer of an alkadiene or a ethylene-propylene copolymer optionally containing a non-conjugated diene. More preferably, the rubber is a homopolymer of a 1,3-conjugated diene such as butadiene, isoprene, piperylene, chloroprene and the like, or a copolymer of a conjugated diene with one or more vinyl aromatic monomers such as styrene; alpha, beta-ethylenically unsaturated nitriles such as acrylonitrile; alpha-olefins such as ethylene or propylene, and the like. Most preferred rubbers are homopolymers of 1,3-butadiene and block or random copolymers of at least about 30, more preferably from about 50 to about 90, weight percent 1,3-butadiene and up to about 70, more preferably from about 5 to about 50, weight percent of a vinyl aromatic compound, preferably styrene. In a preferred embodiment, the rubber of a) is a polybutadiene and the rubber of b) is a polybutadiene or a poly(butadiene-styrene)block copolymer.

The composition of the present invention advantageously contains from 25, generally from 30, preferably from 35, more preferably from 40, and most preferably from 45 to 75, generally to 70, preferably to 65, more preferably to 60 and most preferably to 55 weight percent of the star branched rubber, based on the total weight of the rubber.

The composition of the present invention advantageously contains from 75, generally from 70, preferably from 65, more preferably from 60, and most preferably from 55 to 25, generally to 30, preferably to 35, more preferably to 40 and most preferably to 45 weight percent of the linear diene rubber based on the total weight of the rubber.

The rubber particles typically have a volume average particle size of from 0.2 to 3.0 microns. If a bimodal particle size is produced, the rubber typically comprises from approximately 80 to 85 weight percent of the aforementioned particles and from about 5 to 20 weight percent of particles having a volume average particle size of from 2 to 6 microns.

Alternatively, the rubber particles are dispersed therein in the form of small and large particles, wherein the volume average particle diameter of the small particles is from about 0.1 to about 2 micrometers and the volume average particle diameter of the large particles is from about 2 to about 6 micrometers, characterized in that the rubber particles are produced from a diene rubber having I) from 20 to 80 percent, based on the total weight of said rubber particles, of a high solution viscosity component having a viscosity value ranging from 110 to 500 centipoise and II) from 80 to 20 percent, based on the total weight of said rubber particles, of a low solution viscosity component having a viscosity value ranging from 1 to 100 centipoise, further characterized in that the ratio of solution viscosity of high solution viscosity component to the solution viscosity of low solution viscosity ranges from 1.1 to 500, wherein both components I and II have a 1,4 cis content of greater than 30 percent, and III) the rubber is grafted with monovinylidene aromatic polymer to the extent that there is at least 30 percent monovinylidene aromatic polymer present as grafts on the rubber, wherein the amount of rubber in the polymer represents about 2 to 20 percent based on the total weight of the polymer.

The diene rubbers most suitable for this invention contain two distinct components, which are comprised of a relatively high solution viscosity diene rubber and a relatively low solution viscosity diene rubber. More particularly, the low solution viscosity component of diene rubber useful for the present invention has solution viscosity values from 1, generally from 5, preferably from 10 and more preferably from 20, to 100, generally to 95, preferably to 85 and more preferably to 75. The high solution viscosity component of diene rubber useful for the present invention has solution viscosity values from 110, generally from 115, preferably from 120 and more preferably from 150 to 500, generally to 450, preferably to 430 and more preferably to 400. The low and high solution viscosity components of diene rubbers useful for the present invention are further characterized in that the ratio of solution viscosity of high solution viscosity component to the solution viscosity of low solution viscosity ranges from 1.1, generally from 1.26, preferably from 1.53 and more preferably from 1.76, to 500, generally to 90, preferably to 40 and more preferably to 21.5.

In addition, in order to obtain the proper proportions of the small and large rubber particles, it is preferred if the low solution viscosity component of the rubber material constitutes from about 20 to about 80 weight percent of the total rubber content of the resin, preferably from about 30 to about 70 weight percent. Most preferably neither component is more than about 80 percent of the total rubber in the composition.

Advantageously, to prepare a rubber-reinforced resin using mass or mass/suspension polymerization techniques, the solution viscosity of the rubber of the alkadiene polymer, as measured as a 5 weight percent solution in styrene, will be greater than 40 and less than 400 centipoise (cps) at 25° C. when the viscosity is measured using a Canon-Fenske capillary viscometer (Capillary No. 400, 1.92 mm inside diameter).

The Mooney viscosity values of the radial-type rubbers should be less than about 90, preferably less than about 70 as measured by DIN 53523. In general, to have a rubber, which is sufficiently solid to be handled and processed in a normal fashion, the Mooney viscosity value should be at least about 20 and values of at least about 30 are preferred. The preferred range for the Mooney value is between about 20 and about 90, more preferably between about 30 and about 85, most preferably between about 35 and about 80.

The rubber preferably employed in the present invention typically exhibits a second order transition temperature not higher than about 0° C., preferably not higher than about −20° C. and most preferably not higher than about −40° C. as determined or approximated using conventional techniques, e.g, ASTM Test Method D-746-52-T. Suitable rubbers include alkadienes which include 1,3-conjugated dienes such as butadiene, isoprene, chloroprene or piperylene. Most preferred are homopolymers prepared from 1,3-conjugated dienes, with homopolymers of 1,3-butadiene being especially preferred. Alkadiene copolymer rubbers containing small amounts, for example up to 10 or 15 weight percent, of other monomers such as vinyl aromatics can also be employed if the rubbers meet the other qualifications described herein. The most preferred rubbers are the linear, radial, star, or randomly branched homopolymers of 1,3-butadiene which have a cis content of at least 30 percent.

The rubbers suitable for the present invention can be made by anionic polymerization or Ziegler-Netta polymerization well known to those skilled in the art.

Regarding the rubber materials suitable for use according to the present invention, the essential requirement for the rubber material is that it has a relatively high solution viscosity component and a relatively low solution viscosity component, wherein both components have a 1,4 cis content of at least 30 percent. Suitable rubbers for use herein are the linear, partially coupled rubbers, also called radial or star rubbers, completely coupled rubbers as well as randomly-branched rubbers, other branched polymers and blends of rubbers, such as a blend of linear and branched polymers, meeting the requirements for rubber materials to be employed in this invention. The molecules of these rubber materials have three or more polymer segments coupled by a single polyfunctional element or compound. Radial or star polymers having this designed branching are conventionally prepared using a polyfunctional coupling agent. Methods for preparing star or radial polymers having designed branching are well-known in the art. Methods for preparing a polymer of butadiene of this type using a coupling agent are illustrated in U.S. Pat. Nos. 4,183,877, 4,340,690, 4,340,691 and 3,668,162 and Japanese Patent 59-24 711.

The amount of rubber initially dissolved in the vinyl aromatic monomer is dependent on the desired concentration of the rubber in the final rubber-reinforced polymer product, the degree of conversion during polymerization and the viscosity of the solution. Typically, the amount of rubber initially dissolved in the vinyl aromatic is from 8, preferably from 8.5, more preferably from 9 and most preferably from 9.5 to 15, preferably to 14, more preferably to 13 and most preferably to 12 weight percent, based on the total weight of the composition.

The rubber is typically used in amounts such that the rubber-reinforced polymer product contains from 2, preferably from 3, more preferably from 4 and most preferably from 5 to 20, preferably to 17 percent, more preferably to 15 and most preferably to 12 weight percent rubber, based on the total weight of the vinyl aromatic monomer and rubber components, expressed as rubber or rubber equivalent. The term “rubber” or “rubber equivalent” as used herein is intended to mean, for a rubber homopolymer, such as polybutadiene, simply the amount of rubber, and for a block copolymer, the amount of the copolymer made up from monomer which when homopolymerized forms a rubbery polymer, such as for a butadiene-styrene block copolymer, the amount of the butadiene component of the block copolymer.

Polymerization processes and process conditions for the polymerization of vinyl aromatic monomers, production of rubber modified polymers thereof and the conditions needed for producing the desired average particle sizes, are well known to one skilled in the art. Although any polymerization process can be used, typical processes are continuous bulk or solution polymerizations as described in U.S. Pat. Nos 2,727,884 and 3,639,372, which are incorporated herein by reference.

The polymerization is preferably conducted in the presence of an initiator. Suitable initiators include any initiator capable of imparting the desired grafting of polymer to the rubber particle under the conditions of polymerization and accelerating the polymerization of the vinyl aromatic monomer. Representative initiators include peroxide initiators such as peresters, e.g. tertiary butyl peroxybenzoate and tertiary butyl peroxyacetate, tertiary butyl peroxyoctoate, dibenzoyl peroxide, dilauroyl peroxide, 1.1-bis tertiarybutyl peroxycyclohexane, 1-3-bis tertiarybutylperoxy-3,3,5-trimethyl cyclohexane, di-cumyl peroxide, and the like. Photochemical initiation techniques can be employed if desired. Preferred initiators include tertiary butyl peroctoate, tertiary butyl isopropyl percarbonate, dibenzoyl peroxide, tertiary butyl peroxy benzoate, 1,1-bistertiarybutylperoxy cyclohexane and tertiarybutylperoxy acetate.

Initiators may be employed in a range of concentrations dependent on a variety of factors including the specific initiators employed, the desired levels of polymer grafting and the conditions at which the mass polymerization is conducted. Specifically, initiators may be employed in amounts from 0 to 2000, preferably from 100 to 1500, parts by weight per million parts by weight of vinyl aromatic monomer.

Additionally, a solvent may be used in the polymerization. Acceptable solvents include normally liquid organic materials which form a solution with the rubber, vinyl aromatic monomer and the polymer prepared therefrom. Representative solvents include aromatic and substituted aromatic hydrocarbons such as benzene, ethylbenzene, toluene, xylene or the like; substituted or unsubstituted, straight or branched chain saturated aliphatics of 5 or more carbon atoms, such as heptane, hexane, octane or the like; alicyclic or substituted alicyclic hydrocarbons having 5 or 6 carbon atoms, such as cyclohexane; and the like. Preferred solvents include substituted aromatics, with ethylbenzene and xylene being most preferred. In general, the solvent is employed in amounts sufficient to improve the processability and heat transfer during polymerization. Such amounts will vary depending on the rubber, monomer and solvent employed, the process equipment and the desired degree of polymerization. If employed, the solvent is generally employed in an amount of up to about 35 weight percent, preferably from about 2 to about 25 weight percent, based on the total weight of the solution.

Other materials may also be present in the process of preparing the rubber modified monovinylidene aromatic polymer composition, including plasticizers, e.g. mineral oil; flow promoters, lubricants, antioxidants, catalysts, mold release agents, or polymerization aids such as chain transfer agents, including alkyl mercaptans, e.g. n-dodecyl mercaptan. If employed, a chain transfer agent can be present in an amount of from about 0.001 to about 0.5 weight percent based on the total weight of the polymerization mixture to which it is added.

The temperature at which the polymerization is conducted will vary according to the specific components, particularly initiator, but will generally vary from about 60 to about 190° C.

Crosslinking of the rubber in the resulting product and removal of the unreacted monomers, as well as any solvent, if employed, and other volatile materials is advantageously conducted employing conventional techniques, such as introducing the polymerization mixture into a devolatilizer, flashing off the monomer and other volatiles at elevated temperature, e.g. from 200 to 300° C. under vacuum and removing them from the devolatilizer.

Typically, a bimodal composition is produced by polymerizing a feed of the desired components and a grafting initiator in a series of reactors, wherein the rubber particles are formed and stabilized within the first reactor, then fed to the top of a second reactor, wherein a second feed is added. The second feed may already contained sized rubber particles or may be another monomer/rubber raw material feed which will produce large particles. Methods of preparing bimodal particle size polymers are disclosed in U.S. Pat. No. 5,240,993, which is incorporated herein by reference, and in EP-0096447.

In one embodiment, a portion of the initial feed from the first reactor is additionally fed into the second reactor, preferably at approximately the midpoint of said second reactor. The polymerization mixture containing the rubber particles produced from the first reactor is rapidly mixed with the non-polymerized feed in the second reactor, and rapid phase inversion of the second feed results in the formation of rubber particles having a dense type morphology, and is referred to herein as a “second add” process. To obtain the dense type morphology, the polymerization mixture containing the particles of the first reactor is mixed with the unpolymerized feed in the second reactor, under conditions such that the resultant mixture has a solids content of at least 4 to 5 times the rubber content. The size of the dense particles can be controlled by controlling the agitation and the solids content in the second reactor as is well known in the art.

In terms of a bimodal distribution, it is found that as groups of particles, the group of smaller particles should have a volume average particle diameter of from about 0.2 to about 2 micrometers, preferably to about 1.8 micrometers and most preferably to about 1.5 micrometers and the group of larger particles should have a volume average particle diameter of from about 2.0, preferably from about 2.5 to about 5 micrometers. In terms of broad distribution, it is found that about 80% of particles are in the range of from about 0.2 to about 8 micrometers.

As used herein, the said particle size is the diameter of the rubber particles as measured in the resultant product, including all occlusions of matrix polymer within rubber particles, which occlusions are generally present in the disperse rubber particles of a rubber-reinforced polymer prepared using mass polymerization techniques. Rubber particle morphologies, sizes and distributions may be determined using conventional techniques such as (for larger particles) using a Coulter Counter (Coulter Counter is a Trade Mark) or, particularly for smaller particles, transmission electron microscopy.

Regarding morphology of the rubber particles in the different groups, as is well known, the smaller particles typically have a core-shell (single, major occlusion) or cellular (multiple, minor occlusions) morphology. The larger particles would generally have a cellular or similar multiple-occlusion morphology.

The rubber modified monovinylidene aromatic polymer component (A) is employed in the high impact compositions of the present invention in amounts of at least about 60 parts by weight, preferably at least about 64 parts by weight, more preferably at least about 68 parts by weight, and most preferably at least about 72 parts by weight based on 100 parts by weight of the high impact polymer composition of the present invention. In general, the rubber modified monovinylidene aromatic polymer component (A) is employed in amounts less than or equal to about 90 parts by weight, preferably less than or equal to about 82 parts by weight, more preferably less than or equal to about 77 parts by weight, and most preferably less than or equal to about 72 parts by weight based on 100 parts by weight of the high impact polymer composition of the present invention.

The rubber modified monovinylidene aromatic polymer component (A) is employed in the flame retardant compositions of the present invention in amounts of at least about 40 parts by weight, preferably at least about 50 parts by weight, more preferably at least about 60 parts by weight, and most preferably at least about 65 parts by weight based on 100 parts by weight of the polymer composition of the present invention. In general, the rubber modified monovinylidene aromatic polymer component (A) is employed in amounts less than or equal to about 85 parts by weight, preferably less than or equal to about 80 parts by weight, more preferably less than or equal to about 75 parts by weight, and most preferably less than or equal to about 70 parts by weight based on 100 parts by weight of the flame retardant polymer composition of the present invention.

Component (B) in the flame retardant high impact monovinylidene aromatic polymer composition of the present invention is a polyphenylene ether resin. Such resin is made by a variety of catalytic and non-catalytic processes from the corresponding phenols or reactive derivatives thereof. By way of illustration, certain of the polyphenylene ethers are disclosed in U.S. Pat. Nos. 3,306,874 and 3,306,875, and in Stamatoff, U.S. Pat. Nos. 3,257,357 and 3,257,358. In the Hay patents, the polyphenylene ethers are prepared by an oxidative coupling reaction comprising passing an oxygen-containing gas through a reaction solution of a phenol and a metal-amine complex catalyst. Other disclosures relating to processes for preparing polyphenylene ether resins, including graft copolymers of polyphenylene ethers with styrene type compounds, are found in Fox, U.S. Pat. No. 3,356,761; Sumitomo, U.K. Pat. No. 1,291,609; Bussink et al., U.S. Pat. No. 3,337,499; Blanchard et al., U.S. Pat. No. 3,219,626; Laakso et al, U.S. Pat. No. 3,342,892; Borman, U.S. Pat. No. 3,344,166; Hori et al., U.S. Pat. No. 3,384,619; Faurote et al., U.S. Pat. No. 3,440,217; and disclosures relating to metal based catalysts which do not include amines, are known from patents such as Wieden et al., U.S. Pat. No. 3,442,885 (copper-amidines); Nakashio et al., U.S. Pat. No. 3,573,257 (Metalalcoholate or -phenolate); Kobayashi et al., U.S. Pat. No. 3,455,880 (cobalt chelates); and the like. In the Stamatoff patents, the polyphenylene ethers are produced by reacting the corresponding phenolate ion with an initiator, such as peroxy acid salt, an acid peroxide, a hypohalite, and the like, in the presence of a complexlng agent. Disclosures relating to noncatalytic processes, such as oxidation with lead dioxide, silver oxide, etc., are described in Price et al., U.S. Pat. No. 3,382,212. Cizek, U.S. Pat. No. 3,383,435 discloses polyphenylene ether-styrene resin compositions. All of the above-mentioned disclosures are incorporated herein by reference.

The polyphenylene ether resins are preferably of the type having the repeating structural formula:

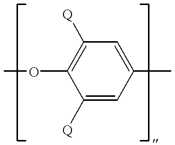

wherein the oxygen ether atom of one unit is connected to the benzene nucleus of the next adjoining unit, n is a positive integer and is at least 50, and each Q is a mono-valent substituent selected from the group consisting of hydrogen, halogen, hydrocarbon radicals free of a tertiary alpha carbon atom, halohydrocarbon radicals having at least two carbon atoms between the halogen atom and the phenyl nucleus, hydrocarbonoxy radicals and halohydrocarbonoxy radicals having at least two carbon atoms.

The preferred polyphenylene ether resin is poly(2,6-dimethyl-1,4-phenylene) ether resin.

The polyphenylene ether resin component (B) is employed in the high impact compositions of the present invention in amounts of at least about 10 parts by weight, preferably at least about 18 parts by weight, more preferably at least about 23 parts by weight, and most preferably at least about 28 parts by weight based on 100 parts by weight of the high impact polymer composition of the present invention. In general, the polyphenylene ether resin component (B) is employed in amounts less than or equal to about 40 parts by weight, preferably less than or equal to about 36 parts by weight, more preferably less than or equal to about 32 parts by weight, and most preferably less than or equal to about 30 parts by weight based on 100 parts by weight of the high impact polymer composition of the present invention.

The polyphenylene ether resin component (B) is employed in the flame retardant compositions of the present invention in amounts of at least about 10 parts by weight, preferably at least about 15 parts by weight, more preferably at least about 18 parts by weight, and most preferably at least about 21 parts by weight based on 100 parts by weight of the polymer composition of the present invention. In general, the polyphenylene ether resin component (B) is employed in amounts less than or equal to about 40 parts by weight, preferably less than or equal to about 35 parts by weight, more preferably less than or equal to about 27 parts by weight, and most preferably less than or equal to about 24 parts by weight based on 100 parts by weight of the flame retardant polymer composition of the present invention.

When a phenol/aldehyde of component (D) of the present is optionally and partially substituted for a polyphenylene ether resin component (B) in the high impact or the flame retardant composition of the present invention, the amount of component (B) needs to be adjusted to maintain the overall compositional balance of other components in the respective retardant polymer compositions of the present invention.

Suitable phosphorous compounds employed in the flame retardant high impact monovinylidene aromatic polymer composition of the present invention as component (C) are organophosphorous compounds which include organophosphates, organophosphonites, organophosphonates, organophosphites, organophosphinites, organophosphinates, or mixtures thereof, as further described hereinbelow.

Suitable organophosphorous compounds are disclosed, for example, in U.S. Pat. Nos. Re. 36,188; 5,672,645; and 5,276,077, teachings of which are incorporated by reference herein. A preferred organophosphorous compound is a monophosphorous compound represented by Formula I:

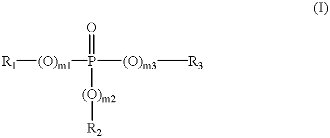

wherein R₁, R₂, and R₃, each represent an aryl or an alkaryl group chosen independently of each other and m1, m2, and m3 each independently of each other are 0 or 1.

Most preferred monophosphorus compounds are monophosphates where m1, m2, and m3 are all 1 and R₁, R₂, and R₃ are independently methyl, phenyl, cresyl, xylyl, cumyl, naphthyl, clorophenyl, bromophenyl, pentachlorophenyl, or pentabromophenyl, for example, trimethyl phosphate, triphenyl phosphate, all isomers of tricresyl phosphate and mixtures thereof, especially tri(4methylphenyl) phosphate, all isomers of trixylyl phosphate and mixtures thereof, especially tri(2,6-dimethylphenyl) phosphate, tricresyl phosphate, all isomers of tricumyl phosphate and mixtures thereof, trinaphthyl phosphate, all isomers of tri(chlorophenyl) phosphate and mixtures thereof, all isomers of tri(bromophenyl) phosphate and mixtures thereof, tri(pentachlorophenyl) phosphate, tri(pentabromophenyl) phosphate, or mixtures thereof.

Another preferred organophosphorous compound is an multiphosphorous compound represented by Formula II:

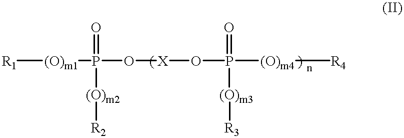

wherein R₁, R₂, R₃, and R₄ each represent an aryl or an alkaryl group chosen independently of each other, X is an arylene group derived from a dihydric compound, m1, m2, m3, and m4 each independently of each other are 0 or 1 and n has an average value greater than 0 and less than 10, when n is equal to or greater than 1. These multiphosphorous compounds are sometimes referred to as oligomeric phosphorous compounds.

Preferred multiphosphorous compounds are multiphosphates where m1, m2, m3, and m4 are 1, R₁, R₂, R₃, and R₄ are independently methyl, phenyl, cresyl, xylyl, cumyl, naphthyl, clorophenyl, bromophenyl, pentachlorophenyl, or pentabromophenyl, X is an arylene group derived from a dihydric compound, for example, resorcinol, hydroquinone, bisphenol A and chlorides and bromides thereof, and n has an average value greater than 0 and less than about 5, preferably n has an average value greater than about 1 and less than about 5. For example preferred oligomeric phosphates having an n value between about 1 and about 2 are m-phenylene-bis(diphenylphosphate), p-phenylene-bis(diphenylphosphate), m-phenylene-bis(dicresylphosphate), p-phenylene-bis(dicresylphosphate), m-phenylene-bis(dixylylphosphate), p-phenylene-bis(dixylylphosphate), Bis phenol-A-bis(diphenylphosphate), Bis phenol A-bis(dicresylphosphate), Bis phenol A-bis(dixylylphosphate), or mixtures thereof.

A most preferred phosphorous compound is a mixture of one or more monophosphorous compounds of Formula I and one or more multiphosphorous compounds of Formula II.

The phosphorous compound component (C) is employed in the flame retardant compositions of the present invention in amounts of at least about 5 parts by weight, preferably at least about 7 parts by weight, and more preferably at least about 9 parts by weight based on 100 parts by weight of the polymer composition of the present invention. In general, the phosphorous compound component (C) is employed in amounts less than or equal to about 20 parts by weight, preferably less than or equal to about 15 parts by weight, more preferably less than or equal to about 13 parts by weight, and most preferably less than or equal to about 11 parts by weight based on 100 parts by weight of the polymer composition of the present invention.

Component (D) which may be optionally used in conjunction with and as a partial substitute for component (B) hereof is a phenol/aldehyde resin. It is well know to prepare these resins by condensation of phenols and aldehydes. Commercial examples of these resins are Novolaks®. Phenol/aldehyde resins having number average molecular weights Mn of from 500 to 2000 are particularly preferably used.

The preparation of phenol/aldehyde resins are described in, for example, in Sårensen and Champbell, Preparative Methods of Polymer Chemistry, Interscience Publishers, New York, 1968, and the thermodynamic properties of novolak/polymer mixtures are described by Fahrenholtz and Kwei in Macromolecules, 14 (1981), 1076-1079.

Novolaks can be prepared using aldehydes (e₁) of the general formula (V)

R¹—CHO

where R¹ is H, C₁-C₁₀-alkyl, cycloalkyl or C₆-C₁₂-aryl or -aryl-C₁-C₃-alkyl. Examples are formaldehyde, acetaldehyde, p-propanal, n-butanal, isopropanal, isobutyraldehyde, 3-methyl-n-butanal, benzaldehyde, p-tolylaldehyde, 2-phenylacetaldehyde, etc. Formaldehyde is particularly preferably used.

Suitable compounds are phenols of the general formula (VI)

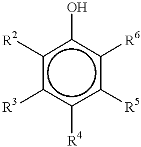

wherein R² and R⁶ are each hydrogen, and R³, R⁴ and R⁵ are each hydrogen, CI-C20-alkyl, cycloalkyl, C₆-C₁₀-aryl, C₁-C₆-alkoxy, cycloalkoxy, C₆-C₁₀-phenoxy, hydroxyl, carbonyl, carboxyl, eyano, a C₁-C₆-alkyl ester radical, a C₆-C₁₀-aryl ester radical, sulfo, sulfonamido, a C₁-C₆-alkyl sulfonate group, a C₆-C₁₀-sulfonic acid ester group, a C₁-C₆-alkyl- or C6-C₁₀-rylphosphinic acid group or its C₁-C₆-alkyl or C₆-C₁₀-aryl ester, a phosphonic acid group or its mono- or di-C₁-C₆-alkyl or mono- or di-C₆-C₁₀-aryl ester or C₆-C₁₀-aryl-C₁-C₆-alkyl ester, or where R² and R⁴ are each hydrogen and R³, R⁵ and R⁶ are each one of the abovementioned radicals.

Typical examples of (e₂), without constituting any restriction, are phenol, o-cresol, m-cresol, p-cresol, 2,5-dimethyl-, 3,5-dimethyl-, 2,3,5-trimethyl-, 3,4,5-trimethyl-, p-tert.-butyl, p-n-octyl-, p-stearyl-, p-phenyl-, p.(2-phenylethyl)-, o-isopropyl-, p-isopropyl-, m-isopropyl-, p-methoxy and p.phenoxyphenol, pyrocatechol, resorcinol, hydroquinone, salicylaldehyde, salicylic acid, p.hydroxybenzoic acid, methyl p-hydroxy-benzoate, p-cyano- and o-cyanophenol, p-hydroxy-benzenesulfonic acid, p.hydroxybenzenesulfonamide, methyl p.hydroxyphenylphosphinate, 4-hydroxyphenylphosphonic acid, ethyl 4-hydroxyphenylphosphonate, diphenyl 4-hydroxyphenylphosphonate and a large number of other phenols. Phenol, o-cresol, m-cresol, p-cresol, p.tert.-butylphenol, o-tert.-butylphenol and p-octylphenol are preferably used.

However, it is also possible to employ mixtures of these phenols.

The phenol/aldehyde resin component (D) is employed in the high impact compositions or in the flame retardant compositions of the present invention in amounts of at least about 2 parts by weight, preferably at least about 4 parts by weight, and more preferably at least about 5 parts by weight based on 100 parts by weight of the respective polymer compositions of the present invention. In general, the phenol/aldehyde resin component (D) is employed in amounts less than or equal to about 20 parts by weight, preferably less than or equal to about 15 parts by weight, more preferably less than or equal to about 8 parts by weight, and most preferably less than or equal to about 7 parts by weight based on 100 parts by weight of the high impact or flame retardant polymer compositions of the present invention.

Additional flame retardants that may be added are triazine skeleton containing compounds. Specific examples of such compounds are melamine, melem, melamine cyanurate and melamine polyphopsphate. These compounds can be employed up to 10% by weight, based on the total weight of the flame retardant composition of the present invention.

In addition, the flame retardant polymer compositions may also optionally contain one or more additives that are commonly used in polymers of this type. Preferred additives of this type include, but are not limited to: antioxidants; impact modifiers; plasticizers, such as mineral oil; antistats; flow enhancers; mold releases; fillers, such as calcium carbonate, talc, clay, mica, wollastonite, hollow glass beads, titaninum oxide, silica, carbon black, glass fiber, potassium titanate, single layers of a cation exchanging layered silicate material or mixtures thereof, and perfloroalkane oligomers and polymers (such as polytetrafluoroethylene) for improved drip performance in UL 94. Further, compounds which stabilize flame retardant polymer compositions against degradation caused by, but not limited to heat, light, and oxygen, or a mixture thereof may be used.

If used, the amount of such additives will vary and need to be controlled depending upon the particular need of a given end-use application, which can easily and appropriately exercised by those skilled in the art.

Preparation of the flame retardant polymer compositions of this invention can be accomplished by any suitable mixing means known in the art, including dry blending the individual components and subsequently melt mixing, either directly in the extruder used to make the finished article or pre-mixing in a separate extruder. Dry blends of the compositions can also be directly injection molded without pre-melt mixing.

The flame retardant polymer compositions of this invention are thermoplastic. When softened or melted by the application of heat, the flame retardant polymer compositions of this invention can be formed or molded using conventional techniques such as compression molding, injection molding, gas assisted injection molding, calendering, vacuum forming, thermoforming, extrusion and/or blow molding, alone or in combination. The flame retardant polymer compositions can also be formed, spun, or drawn into films, fibers, multi-layer laminates or extruded sheets, or can be compounded with one or more organic or inorganic substances, on any machine suitable for such purpose.

The compositions of the present invention are useful to fabricate numerous useful articles and parts. Some of the articles which are particularly well suited include television cabinets, computer monitors, related printer housings which typically requires to have excellent flammability ratings. Flammability ratings are obtained by testing under UL-94 vertical (V) flammability test. This test determines the upward-burning characteristics of a solid. Five test specimens, of a desired thickness measuring 12.5 millimeter (mm) by 125 mm, suspended vertically over surgical cotton are ignited by a 18.75 mm Bunsen burner flame; two ignitions of 10 seconds each are applied to the samples. The rating criteria include the sum of after-flame times after each ignition, glow time after the second ignition, and whether the bar drips flaming particles that ignite the cotton. Table I lists the criteria for each V rating.

TABLE 1

| Rating* | V-2 | V-1 | V-0 |
|---|---|---|---|
| Max individual burn time | 30 | 30 | 10 |
| Burn time of 5 test specimens | 250 | 250 | 50 |
| Glow time after second ignition | 60 | 60 | 30 |
| Ignites cotton | Yes | No | No |

*Rating criteria are reported in seconds

The UL 94 5V flammability test utilizes a 125 mm Bunsen burner flame held at an angle of 20° to a test specimen, of a desired thickness measuring 12.5 mm by 125 mm, suspended vertically over surgical cotton, for 5 seconds, then away from it for 5 seconds, alternating in this pattern for five applications of the flame. After completion of the fifth ignition, the burning time must not exceed 60 seconds to achieve a 5V rating, nor can the cotton be ignited by flaming drips.

The tests employed with the materials of this invention are not intended to reflect hazards present by these or any other materials under actual fire conditions.

The following examples are provided to illustrate the present invention. The examples are not intended to limit the scope of the present invention and they should not be so interpreted. Amounts are in weight percentages unless otherwise indicated.

### EXAMPLES

Rubber modified high impact polystyrene A (HIPS A) contains 4% of a star branched polybutadiene rubber having a solution viscosity of 40 centipoise and 1,4-cis content of 36%, and 4% of a linear rubber having a solution viscosity of 180 centipoise and 1,4 cis content of 38%. The weight average molecular weight of HIPS A is 150,000 and number average molecular weight is 50,000. The volume average rubber particle size is 1.6 microns.

HIPS B contains 3.8% of a polybutadiene rubber having a solution viscosity of 40 centipoise and 1,4-cis content of 95%, and 3.8% of a polybutadiene rubber having a solution viscosity of 200 centipoise and 1,4 cis content of 95%. The weight average molecular weight of HIPS B is 170,000 and number average molecular weight is 75,000. The volume average rubber particle size is 1.3 microns.

HIPS C is for comparative examples and contains 8% of a polybutadiene rubber having a solution viscosity of 180 centipoise and 1,4 cis content of 38%. The weight average molecular weight of HIPS C is 170,000 and number average molecular weight is 70,000. The volume average rubber particle size is 1.5 microns.

A flame retardant, high impact monovinylidene aromatic polymer composition was prepared by thoroughly tumble mixing: (1) a rubber modified high impact polystyrene (HIPS); (2) Noryl 640-111 from General Electric (a polyphenylene ether resin); (3) triphenyl phosphate (TPP, a phosphorous compound); and optionally optionally (4) Bakelite 0790K03 (a phenol/aldehyde resin). The dry blended mixture was then fed to a 30 mm Werner and Pfleider fully intermeshing corotating twin screw extruder using a vibrating feeder. The mixture was compounded in the extruder using a melt temperature setting of 250° C. The resultant polymer strands were cooled in a water bath, air dried and pelletized. The Melt flow rate of the polymer composition was determined according to ASTM D 1238 on a Tinus Olsen plastometer at 200° C. and an applied load of 5 kg. Examples 1, 3 and 5 are flame retardant compositions which illustrate the claims of this invention, while Examples 2 and 4 are comparative examples (Table 2). It can be seen that flame retardant compositions of this invention have higher melt flow rate than compositions made with HIPS C, while maintaining an acceptable high impact strength.

TABLE 2

| Example | 1 | 2 | 3 | 4 | 5 |
|---|---|---|---|---|---|
| HIPS | A | C | B | C | B |
| % HIPS | 65 | 65 | 58 | 58 | 53 |
| % PPO | 25 | 25 | 30 | 30 | 30 |
| % TPP | 10 | 10 | 12 | 12 | 12 |
| % phenol/aldehyde resin | 0 | 0 | 0 | 0 | 5 |
| Melt Flow Rate (g/10 min) | 4.4 | 3.4 | 4.0 | 2.9 | 5.1 |
| Izod Impact (ft-lb/in) | 3.1 | 4.5 | 4.1 | 4.6 | 3.4 |
| UL Flammability Rating | V-2 | V-2 | V-2 | V-2 | V-1 |

What is claimed is:

1. A high impact monovinylidene aromatic polymer compositions comprising
(A) from 60 to 90 percent, based on the total weight of said composition, of comprising a rubber modified monovinylidene aromatic polymer; and
(B) from 10 to 40 weight percent, based on the total weight of said composition, of a polyphenylene ether resin.

2. A flame retardant, high impact monovinylidene aromatic polymer composition comprising:
(A) from 40 to 85 percent, based on the total weight of said composition, of comprising a rubber modified monovinylidene aromatic polymer
(B) from 10 to 40 weight percent, based on the total weight of said composition, of a polyphenylene ether resin; and
(C) from 5 to 20 weight percent, based on the total weight of said composition, of a phosphorous compound.

3. The composition of claim 2 wherein the rubber modified monovinylidene aromatic polymer comprises:
(a) a matrix comprising a monovinylidene aromatic polymer, and
(b) a rubber, in the form of discrete, dispersed rubber particles, dispersed within the matrix, wherein the rubber comprises:
(i) from 75 to 25 weight percent based on the total weight of rubber, of a star branched diene rubber, having a cis 1,4 structure content of less than 75 percent; and
(ii) from 25 to 75 weight percent, based on the total weight of rubber, of a linear diene rubber, having a cis 1,4 structure content of less than 50 percent.

4. The composition of claim 2 wherein the rubber modified monovinylidene aromatic polymer comprises:
(a) a matrix comprising a monovinylidene aromatic polymer, and
(b) a rubber, in the form of discrete, dispersed rubber particles, dispersed within the matrix, wherein the rubber comprises:
(i) from 20 to 80 percent, based on the total weight of said rubber particles, of a high solution viscosity component having a viscosity value ranging from 110 to 500 centipoise;
(ii) from 80 to 20 percent, based on the total weight of said rubber particles, of a low solution viscosity component having a viscosity value ranging from 1 to 100 centipoise, further characterized in that the ratio of solution viscosity of high solution viscosity component to the solution viscosity of low solution viscosity ranges from 1.1 to 500, wherein both components I and II have a 1,4 cis content of greater than 30 percent; and
(iii) the rubber is grafted with monovinylidene aromatic polymer to the extent that there is at least 30 percent monovinylidene aromatic polymer present as grafts on the rubber.

5. The composition of claim 3 or 4 wherein the matrix in the rubber modified monovinylidene aromatic polymer is a styrene polymer.

6. The composition of claim 3 wherein the rubber of (i) or (ii) in the rubber modified monovinylidene aromatic polymer is from 25 to 75 weight percent of total rubber.

7. The composition of claim 3 wherein the rubber of (i) or (ii) in the rubber modified monovinylidene aromatic polymer is butadiene homopolymer.

8. The composition of claim 3 wherein the matrix is a styrene polymer, rubber (i) is a polybutadiene and rubber (ii) is a polybutadiene.

9. The composition of claim 4 wherein the 1,4 cis content of the rubber in the rubber modified monovinylidene aromatic polymer is greater than 30%.

10. The composition of claim 4 wherein the rubber in the rubber modified monovinylidene aromatic polymer is butadiene homopolymer.

11. The composition of claim 4 wherein the matrix is styrene polymer, and the rubber a polybutadiene.

12. The flame retardant composition of claim 2 wherein from 5 to 20 weight percent, base on the total weight of said composition, of the polyphenylene ether resin is optionally substituted with corresponding amount of a phenol/aldehyde resin.

13. The flame retardant composition of claim 2 wherein the phosphorous compound is chosen from the monophosphorous compounds represented by Formula I: 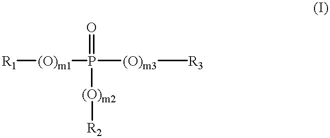
wherein R₁, R₂, and R₃, each represent an aryl or an alkaryl group chosen independently of each other and m1, m2, and m3 each independently of each other are 0 or 1.

14. The flame retardant composition of claim 2 wherein the phosphorous compound is chosen from the multiphosphorous compounds represented by Formula II: 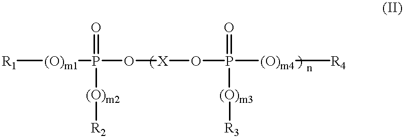
wherein R₁, R₂, R₃, and R₄ each represent an aryl or an alkaryl group chosen independently of each other, X is an arylene group derived from a dihydric compound, m1, m2, m3, and m4 each independently of each other are 0 or 1 and n has an average value greater than 0 and less than about 10.

15. The flame retardant polymer composition of claim 2 wherein the phosphorous compound is a mixture of one or more monophosphorous compounds of Formula I and one or more multiphosphorous compounds of Formula II.

16. The flame retardant polymer composition of claim 2 wherein said composition contains up to 10% by weight, based on the total weight of such composition, melamine cyanurate.

17. The monophosphorous compound of claim 13 wherein R₁, R₂, and R₃, each represent phenyl or 2,6-dimethylphenyl and m1, m2, and m3 each represent 1.

18. The multiphosphorous compound of claim 14 wherein R₁, R₂, R₃, and R₄ each represent phenyl or 2,6-dimethylphenyl; X is an arylene group derived from resorcinol, hydroquinone or bisphenol A; m1, m2, m3, and m4 each represent 1; and n has an average value of greater than about 1 and less than about 5.

19. A method of preparing a flame retardant, high impact monovinylidene aromatic polymer composition comprising the steps of combining:
(A) from 40 to 85 weight percent, based on the total weight of said composition, of comprising a rubber modified monovinylidene aromatic polymer
(B) from 10 to 40 weight percent, based on the total weight of said composition, of a polyphenylene ether resin; and
(C) from 5 to 20 weight percent, based on the total weight of said composition, of a phosphorous compound.

20. The method of claim 19 wherein from 5 to 20 weight percent, base on the total weight of said composition, of the polyphenylene ether resin is optionally substituted with corresponding amount of a phenol/aldehyde resin.
